(19) United States
(12) Patent Application Publication
(10) Pub. No.: US 2009/0077215 A1
(43) Pub. Date: Mar. 19, 2009

(54) Using a managing device to configure and locally manage multiple managed devices

(76) Inventor: Madhavi Jayanthi, Laguna Niguel, CA (US)

Correspondence Address: MADHAVI JAYANTHI, 21 HENLEY DRIVE, LAGUNA NIGUEL, CA, 92677, US

(21) Appl. No.: 11/900,991

(22) Filed: Sep. 14, 2007

(51) Int. Cl. G06F 15/173; G06F 15/177

(52) U.S. Cl. 709/223; 709/220

(57) ABSTRACT

A management network that supports local management of managed devices by a managing device while also supporting remote management by a remote device management (DM) server. The managing device comprises a DM client that exposes a management tree for facilitating remote management by the remote DM server. The DM client comprises nodes in its management tree that correspond to the managed devices. In one embodiment, the remote DM server installs nodes needed to manage the managed devices into the management tree maintained/provided by the DM client of the managing device.

### CROSS REFERENCES TO RELATED APPLICATIONS

### Background

1. Technical Field

The present invention relates generally to the configuration and management of devices locally from a managing device, and more specifically to the management of devices using some features of OMA-DM protocol.

2. Related Art

Electronic devices, such as mobile phones and personal digital assistants (PDA's), are quite common in most workplaces and households. They can be configured and managed using OMA-DM protocol, for example by an operator who might have access to the devices that operate on their networks. Individual devices that are on an operator's network can be managed by a DM server of the operator. However, other devices in the vicinity of one such network managed devices cannot be managed by the DM server of the operator's network if they are also not separately on the network, i.e. if they are also not enabled to participate on the network. However, quite often, these other devices, even if they are capable of being included into the operator's network, will have to have an account and a subscription on the operator's network, which does cost quite a bit adding to the expense of the user. In addition, quite a few such devices are incapable of participating on the operator's network.

Thus, a user is constrained in terms of how many devices in his premises (home or office) can be managed by a DM server—perhaps only his mobile device that has a SIM card (or some other equivalent subscription related information) and an account on an operator's network or in an enterprise network with a device management server. Quite often when a user gets a gets his cell phone or PC managed by a management server, the user cannot get the other devices in proximity managed (configured or updated) because they are not accessible to the management server. Thus, devices in proximity to a managed device are incapable of being managed.

Sometimes, when a managed device receives a management message, the managed device gets configured and updated, but will be out of synch, and become incapable of interacting with other devices that are in physical proximity, but incapable of being managed directly by the management server that sends the management messages. However, including these other devices into the operator's network (management network in general) is likely to cause the user to incur additional charges, and will also require the capability in the other devices in proximity to the managed devices to participate in the management network, such as the operator's wireless network.

Currently only mobile devices, such as cell phones, can be managed by an OMA DM server. In some implementations, a PC can be managed, although most PCs and computers employ a totally different management technology called SNMP. Thus, currently, even if cell phones has a number of other devices in its proximity in a user's house or work premises, only the cell phone can be managed by a DM server that is remotely located.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

The numerous objects and advantages of the present invention may be better understood by those skilled in the art by reference to the accompanying figures in which:

FIG. 1 is a perspective diagram of a management network that supports local management of managed devices by a managing device while also supporting remote management by a remote device management (DM) server;

FIG. 2 is a perspective block diagram of a local network wherein a managing device manages one or more managed devices in its proximity;

FIG. 3 is a local management network wherein a managing device with a DM client manages managed devices each comprising a DM client respectively;

FIG. 4 is an interaction diagram showing exemplary interactions between a managing device and a managed device, some of these interactions triggered remotely from a DM server;

FIG. 5 is a tree diagram showing an exemplary management tree of a DM client in a managing device that comprises managed device specific nodes; and

FIG. 6 is a perspective block diagram of an exemplary local management network wherein a managing device, such as a consumer network gateway, manages multiple consumer devices and appliances, such as a refrigerator, a DVD player and a television.

### DETAILED DESCRIPTION OF THE DRAWINGS

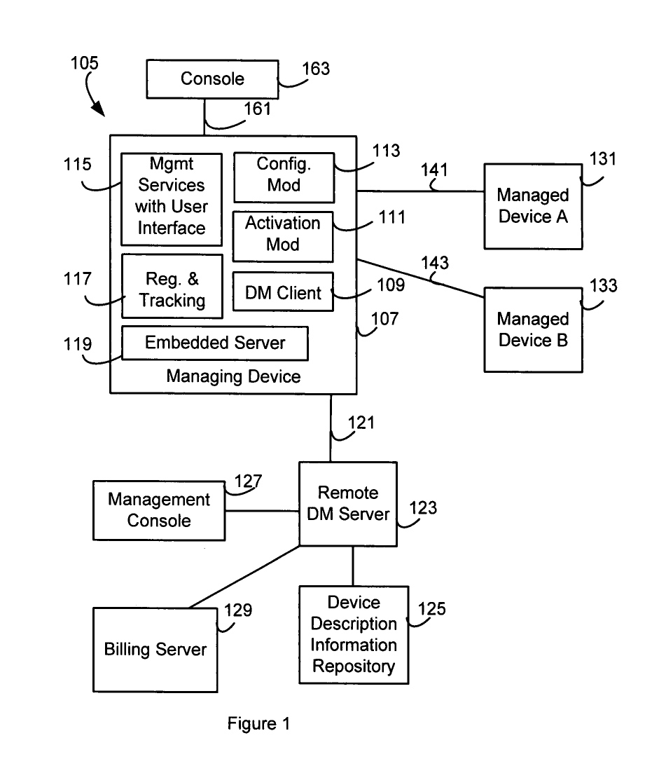

FIG. 1 is a perspective diagram of a management network 105 that supports local management of managed devices 131, 133 by a managing device 107 while also supporting remote management by a remote device management (DM) server 123. The managing device 107 comprises a DM client 109 that exposes a management tree for facilitating remote management by the remote DM server 123. The DM client 109 comprises nodes in its management tree that correspond to the managed devices 131 and 133. The remote DM server 123 installs nodes needed to manage the managed devices 131, 133 into the management tree maintained/provided by the DM client 109 of the managing device 107. The management tree nodes corresponding to the managed devices 131 and 133 could be pre-installed installed in the managing device 107, registered by the managed devices 131 and 133, or installed by the remote DM server 123.

The managing device 107 comprises a configuration module 113 that makes it possible to configure the managing device 107 and an activation module 111 that makes it possible to execute commands, invoke functions and collect data. The remote DM server 123 interacts with the DM client 109 of the managing device 107 which in turn interacts with, as necessary, with the configuration module 113 and the activation module 111.

Employing the nodes corresponding to the managed devices 131, 133, the remote DM server 123 can configure, update and manage the managed devices 131, 133. In addition, the remote DM server 123 can invoke functions, execute commands, etc. in the managed devices 131, 133. The managing device 107 can also be configured and managed by the remote DM server 123.

The managed devices 131, 133 each have corresponding management tree nodes registered/installed in the management tree of the DM client 109 that provide a logical interface for the managing device 107 and the remote DM server 123 to set configuration parameters, invoke commands, update firmware and software as necessary, etc. When the user of the managing device 107 wants to set configuration parameters or invoke commands on any of the managed devices 131, 133, the user can use a management services with user interface 115 that interacts with the DM client 109. In addition, the user can also use a console 161 communicatively coupled to the managing device 107 to set, reset or update configuration parameters and software in the managed devices 131, 133. Similarly, a remote user can employ a management console 127 communicatively coupled to the remote DM server 123 to set, reset or update configuration parameters and software in the managed devices 131, 133.

In one embodiment, each of the managed devices 131, 133 communicate a message, such as a TNDS (tree and node serialization) based message, to the DM client 109 that enables addition of the corresponding management nodes to the management tree of the DM client 109. The managed devices 131, 133 are then able to be managed via the corresponding nodes introduced into the DM client 109 of the managing device 107. When a value is set into these nodes, the DM client 109 of the mobile device 107 communicates it to the associated managed device for setting the appropriate parameter values and changing the configuration. Similarly, when an operation is invoked, such as start or stop, using these nodes, the DM client 109 of the mobile device 107 communicates the operation to the associated managed device for invoking the appropriate operation on the appropriate managed device (131 or 133, as applicable).

In one embodiment, the console 163 is incorporated into the managing device 107. In a different embodiment, the embedded server 119 provides a second means for the remote DM server 123 to interact with the managing device 107 employing web services interfaces, in addition to the standard means of using OMA-DM protocols.

In one embodiment, the OMA-DM client in the managing device makes it possible to interact with OMA-DM clients in the managed devices, wherein the managed devices comprise applications that are configured by the managing device. In a related embodiment, the managed devices are televisions and refrigerators that are communicatively coupled to the managing device and are capable of being managed by the managing device as well as remotely managed by the remote DM server 123. In another related embodiment, the managing device 107 is one of a set-top-box, an ADSL modem, a cable modem, and a 802.11 based WiFi box (router or switch).

In one embodiment, the managing device 107 receives a mobile content employing a bearer communication circuitry and it shares at least one portion of the mobile content locally employing the local communication circuitry with at least one of a plurality of mobile managed devices 131, 133 in its proximity. It manages the sharing of the at least one portion of the mobile content with the at least one of a plurality of mobile managed devices in its proximity 131, 133.

In one embodiment, a device management tree managed by the device management client 109 of the managing device 107 comprises nodes associated with configurations and management operations. The device management tree also comprises a subtree of nodes associated with a second device (such as the managed device 131) communicatively coupled with the managing device 107. The device management client 109 communicates configuration and commands to the second device when the subtree of nodes associated with the second device is manipulated.

In one embodiment, a local management network 105 within a user's premises or a enterprise premises comprises a managing device 107 that is capable of managing a plurality of managed devices 131, 133 locally. Each of the plurality of managed devices comprise a configuration and operations interface that is accessible by the managing device 107. The managing device 107 comprises a configuration and management information for each of the plurality of managed devices 131, 133. The managing device configures and manages at least one of the plurality of managed devices 131, 133 based on its associated configuration and management information, employing the corresponding configuration and operations interface.

In a related embodiment, the managing device 107 conducts the installation of a downloadable client software into at least one of the plurality of managed devices (such as managed device 131). The managing device 107 manages the incorporation of an additional configuration and operations interface to the at least one of the plurality of managed devices that corresponds to the downloadable client software. In addition, the managing device 107 manages the downloadable client software by employing the additional configuration and operations interface.

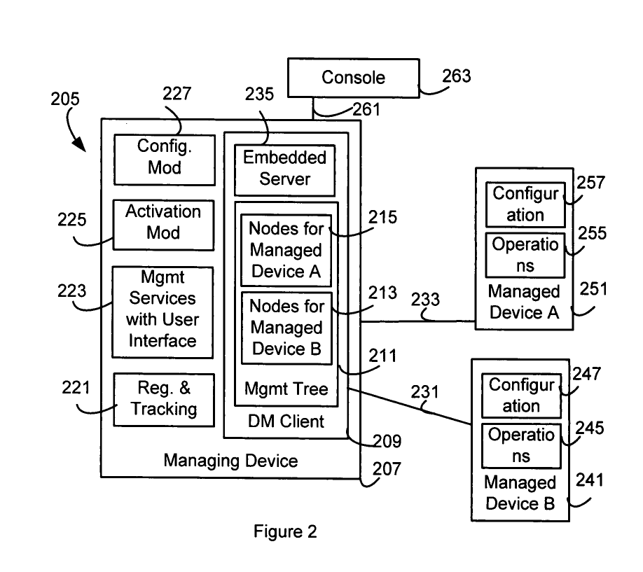

FIG. 2 is a perspective block diagram of a local network wherein a managing device 207 manages one or more managed devices 241, 251 in its proximity. The managing device comprises a DM client 209 that manages the managed devices 241, 251 via a configuration set and operations invoked on corresponding management tree nodes 215, 213 installed or bootstrapped into the DM client 209. By setting values into appropriate nodes of the management tree nodes 215, 213, the DM client 209 effectively sets values (such as configuration, preferences, settings) into the corresponding managed device 251, 241, respectively. Thus, the managing device 207 is capable of exposing the management nodes 213, 215 associated with the managed devices 241, 251 respectively, thereby making those managed devices 241, 251 remotely manageable by a remote management server or locally manageable by the managing device 207.

The managed device B 241 comprises a configuration component 247 and an operations component 245 that are triggered or activated as necessary by the managing device 207 employing a local communications protocol that makes the managed device B 241 communicatively coupled to the managing device 207. Similarly, the managed device A 251 comprises a configuration component 257 and an operations component 255 that are triggered or activated as necessary by the managing device 207 employing a local communications means that may be the same one used to communicate and manage the managed device 241 or a totally different one that is more appropriate. A console 263 communicatively coupled to the managing device makes it possible for a user to view management screens and manage the managed devices 241, 251. In a related embodiment, an embedded server 235 makes it possible to provide the management screens that can be viewed by the user using the console 263 or another device in communicative proximity.

A management services module with appropriate user interfaces 223 makes it possible for a user of the managing device 207 to manage the managed devices 241, 251 and to configure them or operate them as necessary from the managing device 207. Managing devices such as managing device B 241 can register with the managing device 207 for device management services, and they can be subsequently managed by the managing device with its configuration being set or reset and its operations being remotely invoked.

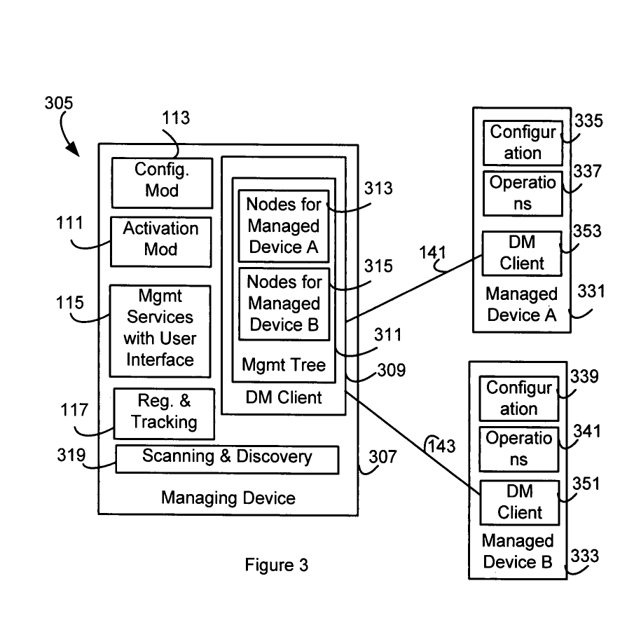

FIG. 3 is a local management network wherein a managing device 307 with a DM client 309 manages managed devices 333, 331 each comprising a DM client 351, 353 respectively. The management tree 311 of the DM client 309 comprises nodes for managed device B 315 and nodes for managed device A 313. By manipulating the comprises nodes for managed device B 315 and nodes for managed device A 313, a remote management server or the managing device 307 can configure the managed devices 333, 331 and also invoke operations and manage them. When the nodes corresponding to the managed devices are registered with the DM client 309, these managed devices become manageable via the managing device 307. In addition, when these nodes are manipulated, the DM client 309 communicates a message to the DM client of the corresponding managed device, which in turn sets configurations, invokes operations, etc. in the managed device.

The managing device 307 comprises a scanning & discovery module 319 that makes it possible for the managing device to search for managed devices in its proximity and establish communications with them, and subsequently facilitate registration of the managed devices and tracking of interactions with them. The managed devices 333, 331 comprise a DM client 351, 331 respectively that are employed to interact with the managing device 307. For example, such interactions can be over a device management protocol such as OMA DM 1.2 from Open Mobile Alliance. The DM client 351 in the managed device 333 interacts with a configuration module 339 to set configurations, access configuration parameters, modify them, etc., and with an operations module 341 to execute commands, update configurations, update firmware and software, reset the device to factory settings, reboot the device, enable and disable the device, etc.

By exposing and manipulating the nodes associated with the managed devices 333, 331, the DM client 309 of the managing device makes it possible to remotely manage the managed devices 333, 331. For example, when the nodes associated with the managed devices 333, 331 are set in the DM client 309, the corresponding configurations in the associated managed devices are set, and corresponding actions takes in those managed devices.

The DM client 309 employs a configuration module 113 and an activation module 111 to configure the managing device and activate operations as necessary.

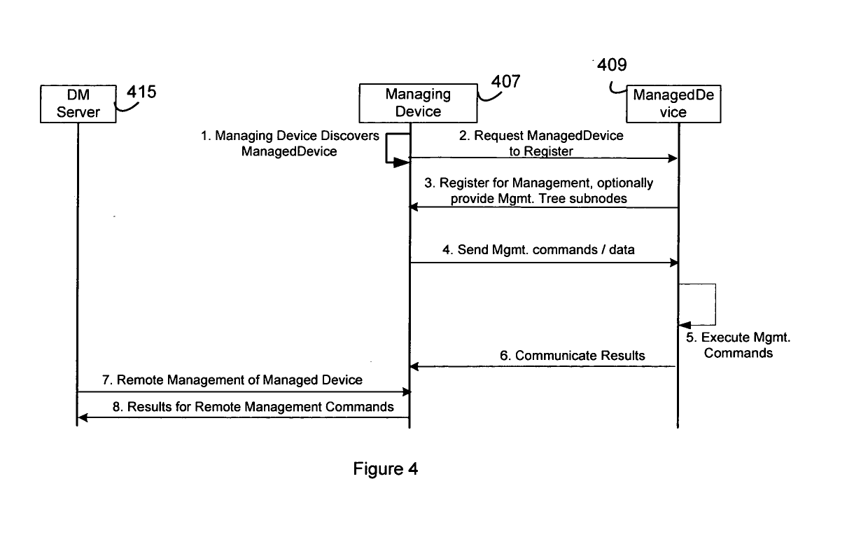

FIG. 4 is an interaction diagram showing exemplary interactions between a managing device 407 and a managed device 409, some of these interactions triggered remotely from a DM server 415. At some point, the managing device 407 discovers the managed device 409. This may occur due to scanning for managed devices by the managing device 407 or due to a presence information provided by the managed device 409 (announcing its presence) to the managing device 407. Then, the managing device makes a request to the managed device to register. The managed devices registers for management, and if necessary, provides management tree subnodes associated with configuration parameters and operations supported by the managed device 409. The managing device 407 then sends management commands and data, such as configuration data or schedules, to the managed device 409. The managed device 405 then executes the commands, sets configuration, schedules, etc. as instructed. It then communicates the results of such operations to the managing device 407.

The DM server 415 may also decide to remotely manage the managed device and send commands and data to the managing device 407 in order to have them implemented on the managed device. For example, the DM server 415 can set configuration in the subnodes of the management tree in the managing device that is associated with the managed device 407. The results of such remote management commands are sent back to the DM server 415 by the managing device 407.

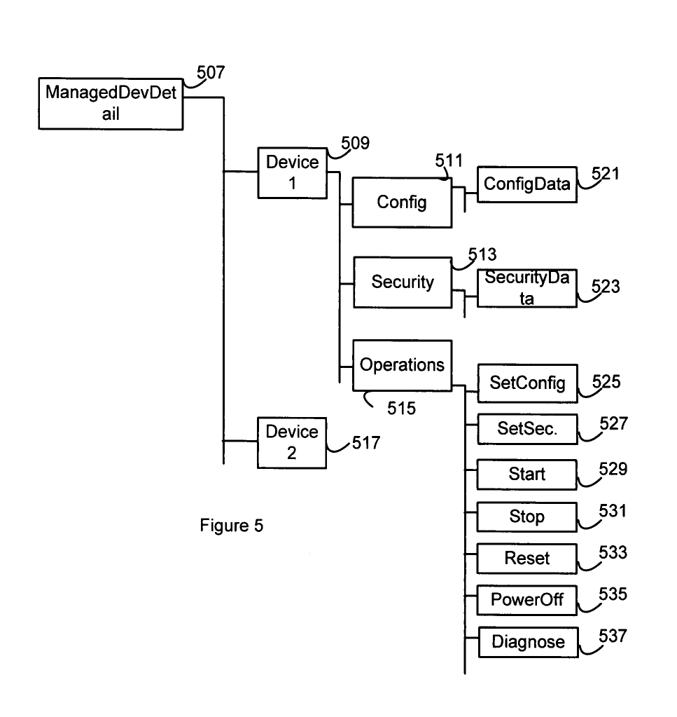

FIG. 5 is a tree diagram showing an exemplary management tree of a DM client in a managing device that comprises managed device specific nodes 509, 517. The managed device specific nodes 509, 517 are grouped under a node called ManagedDevDetail 507, although other locations with different node names are also possible. For each managed device, a group of nodes associated with configuration of the managed device, security information for interactions with the managed device, operations supported by the managed device, etc. are provided. For example, for a managed device represented by a node named Device 1 509, a group of nodes called Config 511, Security 513 and Operations 515 are provided.

Operations supported on a managed device comprise of a setting configuration 525, setting security parameters 517, staring a function in the device 529, stopping a function in the managed device 531, resetting the managed device 533, powering off the managed device 535 and diagnosing problems with the managed device 537. Support for additional operations, such as enable, disable, lock, etc. are also contemplated.

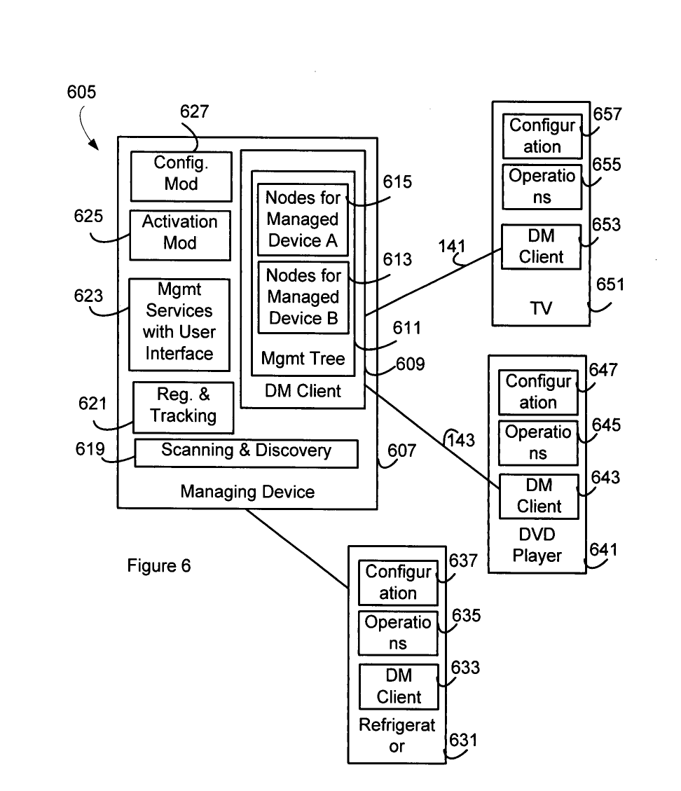

FIG. 6 is a perspective block diagram of an exemplary local management network wherein a managing device, such as a consumer network gateway, manages multiple consumer devices and appliances, such as a refrigerator 631, a DVD player 641 and a television 651. Each of the consumer devices and appliances 631, 641, 651 comprise a DM client 633, 643, 653. The consumer devices and appliances 631, 641, 651 play the role of a managed device. The DM clients in the consumer devices and appliances interact with a configuration module that facilitates configuration management of the associated managed device, and an operations module (such as operations module 655) that supports managed device specific operations, such as start, stop, reset, configure, update, etc. The DM clients in the consumer devices and appliances 631, 641, 651 are embedded DM clients, although downloadable ones that can be installed and updated as needed are also contemplated.

In one embodiment, the management tree subnodes corresponding to the management features of the consumer devices and appliances 631, 641, 651 are installed and managed by the DM client 609 of the managing device. In a related embodiment, the managing device 607 is a consumer network gateway that can manage a plurality of consumer devices employing OMA-DM based device management protocol or a proprietary protocol. When the consumer devices and appliances 631, 641, 651 register with the managing device 607, the managing device 607 either receives a set of management nodes corresponding to the consumer devices and appliances 631, 641, 651, or retrieves them from a remote repository on the internet.

In another embodiment, the management tree subnodes corresponding to the management features of the consumer devices and appliances 631, 641, 651 are installed and managed by the individual DM clients 633, 643 and 653 respectively. In a related embodiment, the managing device 607 is a consumer network gateway that can manage a plurality of consumer devices employing OMA-DM based device management protocol or a proprietary protocol.

In one embodiment, the TV 651 is an IPTV, and the DM client 653 configures the IPTV 651 based upon a configuration information communicated to the IPTV from the managing device 607, which acts as a local management device. The managing device 607 comprises configuration module 627 and an associated configuration interface and management screens. It also comprises a activation module 625 and a management operations interface. The managing device 607, being the local management device for a user, is employed by a user of the IPTV 651 to manage the IPTV 651.

In one embodiment, the IPTV device 651 is communicatively coupled to a remote server. The IPTV device 651 comprises an incoming broadcast receiver that supports multiple channels and a management client 653 that exposes a configuration 657 and management operations 655 interface for management purposes. It also comprises a display screen that is used to display at least one of the multiple channels. The management client 653 configures the IPTV device 651 based upon a configuration information communicated to the IPTV from a remote management server via the configuration 657 and management operations interface 655.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. Likewise, a first circuit and a second circuit may be combined in one embodiment into a single circuit or, in another embodiment, operate independently perhaps in separate chips. The term “chip”, as used herein, refers to an integrated circuit. Circuits and circuitry may comprise general or specific purpose hardware, or may comprise such hardware and associated software such as firmware or object code.

The terms “media” and “content” as used herein may refer to music, recorded voice inputs that a user records, videos, and multimedia information accessed by a user. The media and content may be received by a mobile device in MP3 format, AMR format, WMA format, AVI format, MPEG formats, DVD formats, HDDVD formats, etc.

The term “SMS” as used herein may refer to a textual content delivered over a text based messaging system, such as a text message service that can be provided over a WAP bearer (for example). It includes text messaging over IP networks, such as SMS over IP.

The term “email” as used herein may refer to textual and multi-media content delivered over an electronic mail service, such as mail and files delivered over a push or pull based mail delivery service. It includes textual and multi-media content delivered via a client pull service or a server push service.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

1. A device with a device management (DM) client, the device comprising:
a device management tree managed by the device that comprises nodes associated with configurations and management operations;
the device management tree comprising a subtree of nodes associated with a second device communicatively coupled with the device; and
the DM client communicating a configuration and commands to the second device when the subtree of nodes associated with the second device is manipulated.

2. The device of claim 1 further comprising:
a management user interface that is used by a user; and
the DM client communicating configuration and commands to the second device when the subtree of nodes is manipulated by the user employing the management user interface.

3. The device of claim 1 further comprising:
a communication link with a remote management server employing a management protocol; and
the DM client communicating the configuration and commands to the second device when the subtree of nodes is manipulated by the remote management server.

4. The device of claim 1 further comprising:
the device facilitating the registration of a device description by the second device with the device that results in the incorporation of the subtree of nodes into the management tree.

5. The device of claim 1 further comprising:
the device facilitating the registration of a device description by the remote management server with the device that results in the incorporation of the subtree of nodes into the management tree.

6. The device of claim 1 wherein the management of the second device employing the subtree of nodes can be enabled or disabled.

7. The device of claim 3 wherein the second device is one of an IPTV, an household appliance, a video recorder, a local storage system and a multi-media player.

8. The device of claim 1 wherein the device is one of a set-top-box, a laptop computer, a management console, a modem, a WiFi box, a consumer network gateway and a DVR box.

9. A local management network within a premises comprising:
a managing device capable of managing a plurality of managed devices locally;
each of the plurality of managed devices comprising a configuration and operations interface that is accessible by the managing device;
the managing device comprising a configuration and management information for each of the plurality of managed devices; and
the managing device configuring and managing at least one of the plurality of managed devices based on its associated configuration and management information employing the corresponding configuration and operations interface.

10. The local management network of claim 9 further comprising:
the managing device conducting the installation of a downloadable client software into at least one of the plurality of managed devices;
the managing device managing the incorporation of an additional configuration and operations interface to the at least one of the plurality of managed devices that corresponds to the downloadable client software; and
the managing device managing the downloadable client software employing the additional configuration and operations interface.

11. The local management network of claim 10 further comprising:
the managing device facilitating the management of the at least one of the plurality of managed devices from a remote management server.

12. The local management network of claim 10 further comprising:
the managing device employing a device management protocol to interact with the managed devices and to manage them; and
the managing device employing the device management protocol to interact with the remote management server.

13. The local management network of claim 10 further comprising:
the managing device exposing the configuration and management information of the at least one of the plurality of managed devices to the remote server.

14. The local management network of claim 10 further comprising:
the managing device interacting with the managed devices and managing them; and
the managing device employing the device management protocol to interact with the remote management server.

15. The local management network of claim 9 further comprising:
the managing device managing at least a portion of the at least one of the plurality of managed devices locally; and
a remote management server managing at least another portion of the at least one of the plurality of managed devices remotely.

16. The local management network of claim 15 further comprising:
the managing device managing at least a portion of the at least one of the plurality of managed devices locally employing an OMA-DM based protocol; and
the remote management server managing at least another portion of the at least one of the plurality of managed devices remotely employing the OMA-DM based protocol or one substantially similar to the OMA-DM based protocol.

17. An IPTV device communicatively coupled to a remote server, the IPTV device comprising:
an incoming broadcast receiver that supports multiple channels;
a management client that exposes a configuration and management operations interface for management purposes;
a display screen that is used to display at least one of the multiple channels;
the management client configuring the IPTV based upon a configuration information communicated to the IPTV from a remote management server via the configuration and management operations interface.

18. The IPTV device of claim 17 also comprising:
the management client configuring the IPTV based upon a configuration information communicated to the IPTV from a local management device via the configuration and management operations interface, wherein the local management device is employed by a user of the IPTV.

19. The IPTV device of claim 18 further comprises:
policies;
a plurality of features that are manageable;
a plurality of parameters that are configurable;
the management client managing access to the plurality of features and the plurality of parameters by the remote management server and the local management device based on the policies.

20. The IPTV device of claim 19 wherein the management client is based on an OMA-DM based device management protocol.
